(19) United States
(12) Patent Application Publication
(10) Pub. No.: US 2023/0160601 A1
(43) Pub. Date: May 25, 2023

(54) LOCATING COLLAR FOR INSULATED REGISTER BOX

(71) Applicant: STERLING CUSTOM SHEET METAL, INC., Magnolia, TX (US)

(72) Inventor: Sterling Kidd COMBS, Magnolia, TX (US)

(21) Appl. No.: 18/159,389

(22) Filed: Jan. 25, 2023

Related U.S. Application Data
(63) Continuation-in-part of application No. 18/055,557, filed on Nov. 15, 2022.
Application No. 18/055,557 is a continuation-in-part of application No. 17/196,678, filed on Mar. 9, 2021.
Application No. 17/196,678 is a continuation-in-part of application No. 17/175,956, filed on Feb. 15, 2021.
Application No. 17/175,956 is a continuation-in-part of application No. 17/175,922, filed on Feb. 15, 2021.
Application No. 17/175,922 is a continuation-in-part of application No. 17/171,638, filed on Feb. 9, 2021.
Application No. 17/171,638 is a continuation-in-part of application No. 16/036,059, filed on Jul. 16, 2018, now Pat. No. 11,060,756.
Application No. 16/036,059 is a continuation-in-part of application No. 15/864,612, filed on Jan. 8, 2018, now Pat. No. 10,995,969.
Application No. 15/864,612 is a division of application No. 14/668,079, filed on Mar. 25, 2015, now Pat. No. 9,951,969.
Application No. 16/036,059 is a continuation-in-part of application No. 16/005,235, filed on Jun. 11, 2018, now Pat. No. 11,402,121.
Application No. 16/005,235 is a continuation-in-part of application No. 15/703,436, filed on Sep. 13, 2017, now Pat. No. 10,648,695.
Application No. 15/703,436 is a continuation-in-part of application No. 15/439,454, filed on Feb. 22, 2017, now Pat. No. 10,309,682.
Application No. 15/439,454 is a continuation-in-part of application No. 14/668,079, filed on Mar. 25, 2015, now Pat. No. 9,951,969.

(51) Int. Cl. F24F 13/08; B29C 41/20; F24F 13/06; B29C 44/18

(52) U.S. Cl. CPC F24F 13/082; B29C 41/20; F24F 13/06; B29C 44/18; B29K 2075/00

(57) ABSTRACT

A process for forming an insulated register box includes forming an insulation across the interior surface of a register box, placing a locating collar onto an outer surface of the register box, marking the outer surface of the register box so as to present a representation corresponding to an inner diameter of the collar, separating a portion of the outer surface of the register box from a remainder of the register box corresponding to the marked representation, penetrating the exposed insulation with the collar until an end of the collar opens to an interior of the insulated register box, and positioning the flange against the outer surface of the register box.

### CROSS-REFERENCE TO RELATED APPLICATIONS

The present application is a continuation-in-part of U.S. patent application Ser. No. 18/055,557, filed on Nov. 15, 2022. U.S. patent application Ser. No. 18/055,557 is a continuation in part of U.S. patent application Ser. No. 17/196,678, filed on Mar. 9, 2021, presently pending. U.S. patent application Ser. No. 17/196,678 is a continuation-in-part of U.S. patent application Ser. No. 17/175,956, filed on Feb. 15, 2021, presently pending. U.S. patent application Ser. No. 17/175,956, is a continuation-in-part of U.S. patent application Ser. No. 17/175,922, filed on Feb. 15, 2021, presently pending. U.S. patent application Ser. No. 17/175,922 is a continuation-in-part of U.S. patent application Ser. No. 17/171,638, filed on Feb. 9, 2021, presently pending. U.S. patent application Ser. No. 17/171,638 is a continuation-in-part of U.S. patent application Ser. No. 16/036,059, filed on Jul. 16, 2018, which issued as U.S. Pat. No. 11,060,756 on Jul. 13, 2021. U.S. patent application Ser. No. 16/036,059 is a continuation-in-part of U.S. patent application Ser. No. 15/864,612, filed on Jan. 8, 2018, which issued as U.S. Pat. No. 10,995,969 on May 4, 2021. U.S. patent application Ser. No. 15/864,612 is a divisional of U.S. patent application Ser. No. 14/668,079, filed Mar. 25, 2015, which issued as U.S. Pat. No. 9,951,969 on Apr. 24, 2018. U.S. patent application Ser. No. 16/036,059 was also a continuation-in-part of U.S. patent application Ser. No. 16/005,235, filed on Jun. 11, 2018, which issued as U.S. Pat. No. 11,402,121 on Aug. 2, 2022. U.S. patent application Ser. No. 16/005,235 is a continuation-in-part of U.S. patent application Ser. No. 15/703,436, filed on Sep. 13, 2017, which issued as U.S. Pat. No. 10,648,695 on May 12, 2020. U.S. patent application Ser. No. 15/703,436 is a continuation-in-part of U.S. patent application Ser. No. 15/439,454, filed Feb. 22, 2017, and which issued as U.S. Pat. No. 10,309,682 on Jun. 4, 2019. U.S. patent application Ser. No. 15/439,454 was a continuation-in-part of U.S. patent application Ser. No. 14/668,079, filed on Mar. 25, 2015, and which issued as U.S. Pat. No. 9,951,969 on Apr. 24, 2018.

### BACKGROUND OF THE INVENTION

### 1. Field of the Invention

The present invention relates to ductwork for heating, ventilation and air-conditioning (HVAC) systems. More particularly, the present invention relates to register boxes as used in such systems. More particularly, the present invention relates to register boxes that are adaptable to the various sizes of ductwork employed in the HVAC systems.

### 2. Description of Related Art Including Information Disclosed Under 37 CFR 1.97 and 37 CFR 1.98

To create the desired ambient conditions within a structure, a typical HVAC system is installed for circulating and/or conditioning air drawn from the interior of the structure and returned to the interior of the structure. A central unit or several units are located in or near the structure, each unit comprising a fan for air circulation and optionally comprising a heating, humidification, or cooling system for conditioning the air passing through the central unit.

To conduct air to and from each central unit, ducting is provided in the structure. The ducting includes supply-air ducts which provide conditioned air to the interior of the structure and are connected to the outlets of each central unit and return-air ducts which return air to each central unit and are connected to inlets of each central unit. Supply-air ducts typically terminate in supply-air register boxes mounted to the walls, the ceilings, or other surfaces within the interior, whereas return-air ducts typically begin at register boxes mounted to a surface within the interior, such as a wall, ceiling, or floor. There are usually many more register boxes for supplying air than for returning air, with those for returning air typically being substantially larger than those for supplying air.

To increase efficiency, building codes are being revised to require substantially airtight HVAC systems. In the past, a standard technique has been utilized for forming such sheet-metal register boxes. A form is cut from a rectangular, planar metal sheet. The form has cutouts for corners or other features to allow bending of the form into the desired shape. Cutouts define the height of the sides and an overlapping flap is formed by cutting a slot at each cut out. The sides are bent along bend lines to lie in intersecting planes so as to form an open-bottom, rectangular enclosure of a register box, with the vertical edges of the sides abutting the inside surfaces of the sides. The flap is folded around each corner that lies adjacent the outer surface of the side and then fastened to the side with rivets. In order to complete the register box, a circular duct connector or is connected to a circular cutout in the upper surface of the box. Prior art register boxes are also formed with abutting edges to form the enclosure. The abutting or overlapping edges may be fastened by adhering or by other fastening means, such as spot welding.

The method described above produces ducting enclosures that often leak conditioned air through the gaps between the edges at the corners, or, in the case of enclosures formed with multiple pieces, through the seams where the pieces are joined together. The prior-art method includes many labor-intensive steps to form the enclosures, including the cutting of the planar sheet and the fastening of the edges.

In order to achieve the requisite efficiency in compliance with building codes, insulation is used with such register boxes. The formation of the insulation of the register boxes has become somewhat of a problem. Since the boxes are conventionally made of sheet metal, such as galvanized steel or aluminum, the insulation must be applied to either or both the inside and outside of the register box either before or after it is installed. The cutting and fastening of the insulation to the box is tedious and time-consuming. As such, it is thereby rather expensive in terms of the cost of the insulation material and in terms of the amount of time required to properly insulate the register box.

The placement of insulation can be a time-consuming, hazardous, and tedious task. Typically, a large section of fibrous material requires a cutting into various shapes that fit within the interior of the register box. This fibrous material is then affixed to the walls on the inside of the register box by hand. Often, many steps are required so as to properly fit the insulation material within the register box. Furthermore, since fibrous material is being manually handled by workers, there can be exposure to airborne fibers. The cutting and fitting of the insulation material within the register box is extremely tedious and boring to workers.

In the past, various patents have issued relating to register boxes and to the insulating of such register boxes. For example, U.S. Pat. No. 3,985,158, issued on Oct. 12, 1976 to J. V. Felter, describes a box for mounting diffusers wherein the main body of the box is made of expanded plastic or similar material. One or more connection elements are molded within the walls of the box to provide for connection of the box to the building structure and to a duct and also to reinforce the box.

U.S. Pat. No. 4,735,235, issued on Apr. 5, 1988 to Anderson et al., discloses an insulated duct end system. The system includes duct assemblies and transition components for interconnecting the duct assemblies. Each duct assembly includes an insulated duct having a rigid sleeve within at least one end. Each sleeve includes an abutment ring and orifices in the ring for permitting air to flow into the insulated area to balloon the layer and improve its insulative effect.

U.S. Pat. No. 5,095,942, issued on Mar. 17, 1992 to G. C. Murphy, teaches a plastic self-insulating ductwork system. The system includes a distribution box which includes an upper portion having a plurality of walls and a bottom plate. The distribution box is joined to interconnecting duct lines by adapter conduits. The adapter conduits are adapted at one end for connection to an opening in the wall and are adapted at the other end for connection to an adjoining duct line. U.S. Pat. No. 5,219,403, issued on Jun. 15, 1993 the G. C. Murphy, discloses a similar type of self-insulating ductwork system as that of U.S. Pat. No. 5,095,942.

U.S. Pat. No. 5,658,196, issued on Aug. 19, 1997 to T. L. Swaim, provides an air duct diffuser for attachment to a ceiling grid. The diffuser includes a frame which mounts to the ceiling grid and a louver which mounts to the frame for directing diffused air within an associated airspace. A pre-formed composite housing of insulating material mounts to the frame and has punch-out duct openings of varying sizes.

U.S. Pat. No. 5,749,190, issued on May 12, 1998 to S. R. Williams, shows an HVAC register box having no welded or riveted corners and also a process for making such an HVAC register box. The register box is fabricated from a single sheet of material without cutting. The register box has superior rigidity and resistance to air leakage at the joints or corners.

U.S. Pat. No. 5,957,506, issued on Sep. 28, 1999 to M. D. Stepp, provides a sheet-metal insulated register box. The register box has an adjustable elbow fitting that is coupled directly to an air inlet panel of an air distribution register box by having roll-formed flange portions that are mated in interlocking, overlapping engagement with each other. The air inlet panel includes an outwardly flared coupling flange bordering an air inlet opening. The neck of the sheet-metal elbow includes a folded coupling flange that is dimensioned for interfitting, overlapping engagement with the outwardly-flared elbow coupling flange.

U.S. Patent Publication No. 2008/0014860, published on Jan. 17, 2008 to Heitman et al., discloses a method and apparatus for eliminating register boxes. A collar plate assembly interfaces with metal air ducts and is provided with at least one spring indentation ring to accept two or more locking springs. The locking springs are used to attach the ceiling register to the collar plate assembly. The collar plate assembly uses mounting rails that attach the assembly to either the ceiling or wall supports. A trim ring is inserted in the cutout that attaches between the collar in the ceiling so as to eliminate air leakage and so as to provide an essentially smooth flow of air from the supply duct to the inside of the structure.

U.S. Patent Publication No. 2004/0130154, published on Jul. 8, 2004 to Stepp et al., shows a substantially airtight register box for HVAC systems. The register box has a body formed from at least one planar sheet. The body has an inlet and outlet. At least one of the inlet and the outlet is formed by folding corners of the planar sheet to form planar sides that lie in intersecting planes. The enclosure is then mounted to a surface of an interior area of a structure and is connected to ducts for communicating air between the interior area at a central air-handler unit.

U.S. Patent Publication No. 2008/0045137, published on Feb. 21, 2008 F. Rosal, discloses an insulated plenum box for heating, ventilating and air conditioning duct systems. This plenum box has insulation sprayed onto either the inside or outside of the plenum box in order to match the R-value of the connecting insulated duct.

The present Applicant is the owner of several patents and patent application publications related to such register boxes and the processes for forming such register boxes. For example, U.S. Patent Application No. 2018/0363942, published on Dec. 20, 2018 to the present Applicant, describes an insulated register box and process for forming the insulated register box. This register box has a body with a plurality of side walls arranged in a generally rectangular or square configuration and a plurality of flanges extending inwardly from the plurality of side walls. An expandable polymeric material is affixed to an inner side of each of the plurality of side wall such that the expandable polymeric material has a portion extending across one end of the body inwardly of the plurality of flanges. A sheet is positioned over the portion of the expandable polymeric material at one end of the body such that the sheet is interposed between the plurality of flanges and the portion of the expandable polymeric material. The expandable polymeric material and the sheet are cuttable so as to open to the interior of the register box.

U.S. Pat. No. 10,648,695, issued on May 12, 2020 to the present Applicant, describes a register box with a boot rail adapter that has an insulating material affixed within the register box, a guide rail affixed to a side panel of the register box, and a rail having a section received in a slot of the rail guide. The rail is adapted to be affixed to a supporting surface, such as a joist. The rail guide is slidable relative to the rail. The rail guide is affixed to an exterior surface of the side panel.

U.S. Pat. No. 10,309,682, issued on Jun. 4, 2019 to the present Applicant, teaches a process for insulating a register box in which the register box has a plurality of side panels arranged in a generally rectangular configuration and a duct opening through a wall that extends across the generally rectangular configuration. This process involves flowing an expandable polymeric material toward the plurality of side panels, placing the register box into or onto a support structure, introducing a liner over the flowed expandable polymeric material within the register box, and placing a form onto the liner in the register box so as to shape the expandable polymeric material within the register box. The form and the liner then removed from the register box.

U.S. Patent Application Publication No. 2018/0320921, published on Nov. 8, 2018 to the present Applicant, teaches an insulated register box apparatus with a boot rail adapter which has an insulating material affixed within the register box, a rail affixed to a side panel of the register box, and a rail guide having a slot that receives a section of the rail therein. The rail guide is adapted to be affixed to a supporting surface. The rail is affixed at least one of the side panels of the register box. The rail is slidable relative to the rail guide. The register box has a plurality of side panels and a duct that opens to an interior of the plurality of side panels. The insulating material extends inwardly of the plurality of side panels.

U.S. Patent Application Publication No. 2018/0187919, published on Jul. 5, 2018 to the present Applicant, teaches an insulated register box for HVAC installations that has a body with a plurality of side panels arranged in a generally rectangular or square configuration and a wall extending across the rectangular configuration. A duct opens through the wall so as to communicate with an interior of the body. An expandable foamed polymeric material is affixed to an inner side of the side panels. The wall has a surface extending from the opening of the duct to the side panels. The expandable foamed polymeric material is affixed to the surface of the wall.

U.S. Pat. No. 9,951,969, issued on Apr. 24, 2018 to the present Applicant, describes an insulated register box and a method for forming such an insulated register box. The register box has a body with a plurality of side panels arranged in a generally rectangular or square configuration and a wall extending across the rectangular configuration. A duct opens through the wall so as to communicate with the interior of the body. An expandable foamed polymeric material is affixed to an inner side of the side panels. The wall has a surface extending from the opening of the duct to the side panels. The expandable foamed polymeric material is affixed to the surface of the wall.

Upon the commercialization of the insulated register box of U.S. Pat. No. 9,951,969, it was determined that certain operations and HVAC systems had different sizes of duct and different needs associated with the insulated register box. In particular, in this prior patent, the duct was of a particular size and was integrated in the structure of the register box. However, difficulties could occur if a customer had a duct system or air movement system which was incompatible with the duct that was incorporated into the structure of the register box. Under such circumstances, creative efforts would be required so as to fit a large duct of the HVAC systems with the smaller collar of the register box. Similarly, other creative efforts would be required in order to properly secure a smaller duct with a wider collar of the register box. This adaptation and creative efforts would require relatively skilled personnel in order to complete a secure and airtight connection. As such, a need developed so as to create a more adaptable register box in which a person can create an opening in the register box that is adaptable to the particular ducting and air movement systems to which the insulated register box is applied. In such a situation, it is important that the insulating expandable polymeric material be adaptable so as to generally engage with the exterior of the external ducting to which the insulated register box is applied. This need requires the ability to connect the register box to the ductwork without special tools, installation equipment, or complicated procedures.

U.S. patent application Ser. No. 18/055,557 is an earlier application pertaining to the present invention. This patent application described a register box for an HVAC installation that is a body with a plurality of side panels arranged in a generally rectangular or square configuration and a wall extended a generally transverse relation to the plurality of side panels. An expendable polymeric material is affixed to an inner side of the side panels and across the wall. The wall has a plurality of concentric circular areas cut into the wall. Each of the concentric areas is formed of a first partial circle having ends in spaced relation to a second partial circle. The circular area can be removed from the wall so as to allow a user to cut through the polymeric material at the wall so as to form a hole opening to an interior of the register box. The hole can receive a collar therein. This collar can be connected to the HVAC system.

In relation to this earlier application, it was found that, under any circumstances, it was necessary to choose various sizes of collars to fit the ductwork of the HVAC system. It was important to be able to install the collar with minimal damage to the insulating material surrounding the collar. It was felt that when the insulation material was subject to a sawing or cutting operation in order to allow the collar to be fit therein, too much insulation could be removed thereby impairing the insulating quality of the insulation within the register box. In other circumstances, it was difficult for the installer to make proper decisions as to the proper size of the collar for fitting the particular register box. It was important to choose a collar that did not protrude into the insulation near the sides of the register box. Under certain circumstances, it was desirable to properly center or to place the collar near center in many applications. This prior register box, with the removable circular areas assured a central location of the collar. However, under those circumstances where it would be more desirable to place the collar slightly off center, the register box of this prior application became slightly difficult to use. As such, a need developed so as to provide a register box/collar combination which was readily adaptable to the size and configuration of the register box, which allowed the collar to be placed in any desired location on the exterior surface of the register box, avoided unnecessary destruction of the insulating material within the register box, and which provided a guide for the proper placement of the collar on the register box.

It is a further object of the present invention to provide a process for installing a collar on a register box that makes the register box substantially airtight.

It is object of the present invention to provide a process and system for forming a register box that is adaptable to the ductwork of an HVAC system.

It is another object of the present invention to provide a process and system for forming a register box that has a better seal when installed with the HVAC system.

It is another object of the present invention to provide a process and system for forming a register box that can be customized to the particular ductwork of the HVAC system.

It is another object of the present invention to provide a process and system for forming a register box that provides the unskilled worker with a guide in order to form a correctly cut and dimensioned hole in the register box.

It is another object of the present invention to provide a process and system for forming a register box that allows unskilled workers to install the register box with the HVAC system.

It is another object the present invention to provide a process and system for forming a register box that is energy efficient.

It is another object of the present invention to provide a process and system for forming a register box that is relatively inexpensive.

It is a further object of the present invention to provide a process and system for forming a register box that has a smaller footprint when shipping and storing.

It is another object of the present invention to provide a process and system for forming a register box that minimizes air loss.

It is another object of the present invention to provide a process and system for forming a register box that improves insulation rating.

It is another object of the present invention to provide a process and system for forming a register box that is fire resistant.

It is another object to the present invention to provide a process and system for forming a register box that is compliant with national building codes.

It is a further object of the present invention to provide a process and system for forming a register box that avoids fibrous insulation.

It is still another object of the present invention to provide a process and system for forming a register box that improves the health and safety of the workers.

It is another object of the present invention to provide a process and system that provides a tool to help locate the collar on the register box while in the field.

It is another object of the present invention to provide a process and system for placing a collar on a register box which avoids the removal of excess insulation.

It is still another object of the present invention to provide a process and system for installing a collar on an insulated register box that allows for the cutting of a perfect circle in the insulation.

It is still a further object of the present invention to provide a process and system for installing a collar on an insulated register box that provides a secondary mechanical connection between the collar and the metal of the register box.

It is still another object of the present invention provide a process and system for installing a collar on the register box which offers a wide surface for securing the flange of the collar to the register box.

It is still a further object of the present invention to provide a process and system for installing a collar on a register box that provides a better quality of insulated register box.

It is another object of the present invention provide a process for installing a collar on the register box that serves as a measuring device, a template and a mounting flange.

It is still a further object of the present invention to provide a process and system for installing a collar on to a register box that offers a secondary fire barrier.

It is a further object of the present invention to provide a process and system or installing a collar on a register box that makes the register box substantially airtight.

These and other objects and advantages of the present invention will become apparent from a reading of the attached specification and appended claims.

### BRIEF SUMMARY OF THE INVENTION

The present invention is a process for forming an insulated register box. This process includes the steps of: (1) forming an insulation across interior surfaces of the register box; (2) placing a locating collar onto an outer surface of the register box; (3) marking the outer surface of the register box so as to have a representation corresponding to an inner diameter or outer diameter of the collar; (4) separating the portion of the outer surface of the register box from a remainder of the register box corresponding to the marked representation so as to expose a portion of the insulation; (5) penetrating the exposed portion of the insulation with the collar until an end of the collar opens to an interior of the insulated register box; (6) removing the insulation interior of the collar; and (7) positioning the flange against the outer surface of the register box. The locating collar has a collar with the flange extending circumferentially therearound.

The collar has an outer diameter. The flange also has an outer diameter. A width of the flange between the outer diameter of the collar and the outer diameter of the flange is greater than the thickness of the insulation. The outer surface of the register box has a width dimension greater than an outer diameter of the flange.

The flange is affixed around the outer diameter of the collar in a location between the opposite ends of the collar. An inner diameter edge of the flange is inserted into a notch formed around the outer diameter of the collar.

The step of separating includes snippng a surface of the register box around the marked representation and removing the snipped surface from the remainder of the register box. The step of penetrating the insulation includes pushing an end of the collar through the insulation until the flange abuts the outer surface of the register box. The flange is affixed to the outer surface of the register box. A fastener is applied to the flange so as to engage with the outer surface of the register box. In particular, a mastic can be applied around the outer diameter of the flange and to the outer surface of the register box. The flange has an inner diameter received within the notch. An edge of the outer surface of the register box is also fit into the notch of the collar.

The present invention is also a locating collar for use with an insulated register box. This locating collar has a collar having a first end and a second end, and a flange affixed to the outer diameter of the collar. The flange extends radially outwardly of the collar. The flange has an outer diameter greater than the outer diameter of the collar. The flange is positioned in a location between the first end and the second end of the collar. The second end of the collar is adapted to extend through the insulation of the register box such that an interior of the collar opens to a cavity within the interior of the insulated register box.

The distance between the outer diameter of the collar and the outer diameter of the flange is greater than a thickness of the insulation in the register box. The outer diameter of the flange is less than a width of the outer surface of the insulated register box. The collar has a notch formed therearound. The flange has an inner diameter received in the notch of the collar.

The present invention is also an insulated register box assembly. This assembly includes a register box having an outer surface and an insulating material applied to an inner surface of the register box. The insulating material has a thickness. The register box has an interior cavity. A collar is provided having a flange affixed thereto. The flange radiates outwardly of the collar. The flange bears against the outer surface of the register box. The collar has a portion extending through the thickness of the insulating material so as to have an end opening to the interior cavity of the register box. The collar has another portion extending outwardly of the outer surface of the register box.

The assembly of the present invention has a notch formed in the collar. This notch extends circumferentially around the collar. The flange has an inner diameter received within the notch. The outer surface of the register box has an edge also received in this notch. A mastic is applied to an outer diameter of the flange and to the outer surface of the register box so as to form an airtight seal therebetween. The outer diameter of the flange and an outer diameter of the collar defines a distance that is greater than a thickness of the insulating material. The flange has an outer diameter less than a width of the outer surface of the register box.

This foregoing Section is intended to describe, with particularity, the preferred embodiments of the present invention. It is understood that modifications to these preferred embodiments can be made within the scope of the present claims. As such, this Section should not be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view of the locating collar in accordance with the teachings of the present invention.

FIG. 2 is a plan view showing the locating collar of the present invention.

FIG. 3 is a plan view showing the locating collar of the present invention as placed upon an outer surface of a register box.

FIG. 4 illustrates a marking carried out on the outer surface of the register box.

FIG. 5 is a side elevational view showing the placement of the locating collar upon the outer surface of the register box.

FIG. 6 is a cross-sectional view showing the locating collar as placed upon the outer surface of the register box.

FIG. 7 is a plan view showing a portion of the outer surface of the register box that is removed so as to expose the insulation thereunder.

FIG. 8 is a cross-sectional view showing the insertion of the locating collar of the present invention through the insulation of the register box of the present invention.

FIG. 9 is a detailed cross-sectional view showing the engagement between the flange of the locating collar and the edge of the outer surface of the register box within a notch formed on the locating collar.

FIG. 10 is a side cross-sectional view showing the use of the locating collar of the present invention in conjunction with a sidewall of the register box.

### DETAILED DESCRIPTION OF THE INVENTION

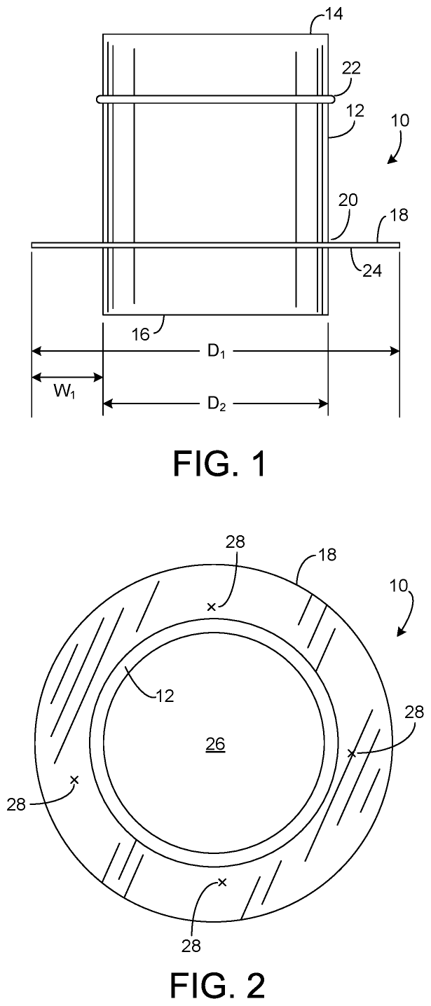

FIG. 1 shows locating collar 10 in accordance with the preferred embodiment of the present invention. Locating collar 10 includes a collar 12 having a first end 14 and a second and 16. The collar has an outer diameter D₂. A flange 18 is affixed to the outer diameter D₂ of the collar 12. The flange 18 extends radially outwardly of the collar 12. The flange 18 has an outer diameter D₁. Diameter D₁ is greater than the outer diameter D₂ of the collar 12. The flange 18 is positioned in a location between the first end 14 and the second end 16 of the collar 12. The second end 16 is adapted to extend through the insulation of the register box such that an interior of the collar 12 opens to a cavity within an interior of the register box (to be described hereinafter).

A distance between the outer diameter D₂ of the collar 12 and the outer diameter D₁ of the flange is greater than a thickness of the insulation in the insulated register box. The outer diameter D₁ of the flange 18 is less than a width of a surface of the insulated register box. The flange 18 will have an inner diameter that is received within a notch 20 formed circumferentially in the collar 12.

In FIG. 1, it can be seen that there is a ridge 22 that is formed adjacent to the first end 14 of the collar 12. The second end 16 of the collar 12 will be sufficiently sharp so as to allow the second end 16 to dig through the insulation of the register box. The flange 18 has a generally annular configuration. The bottom surface 24 of the flange 18 is adapted to bear against the outer surface of the register box.

FIG. 2 is a plan view of the locating collar 10 of FIG. 1. In particular, it can be seen that the collar 12 has an annular configuration with an open interior 26. Open interior 26 can be used to connect to the ductwork of an HVAC system. Ultimately, the open interior 26 will open to the interior cavity of the insulated register box (as will be described hereinafter). FIG. 2 shows that the flange 18 has an annular configuration. The inner diameter of the flange 18 will be engaged with a notch formed circumferentially around the collar 12. The flange 18 has markings 28 on a surface thereof. These markings 28 can be in various positions and can be of various numbers, but are used so as to designate proper locations for inserting screws, or other fasteners, for the purposes of joining the flange 18 to the outer surface of the register box.

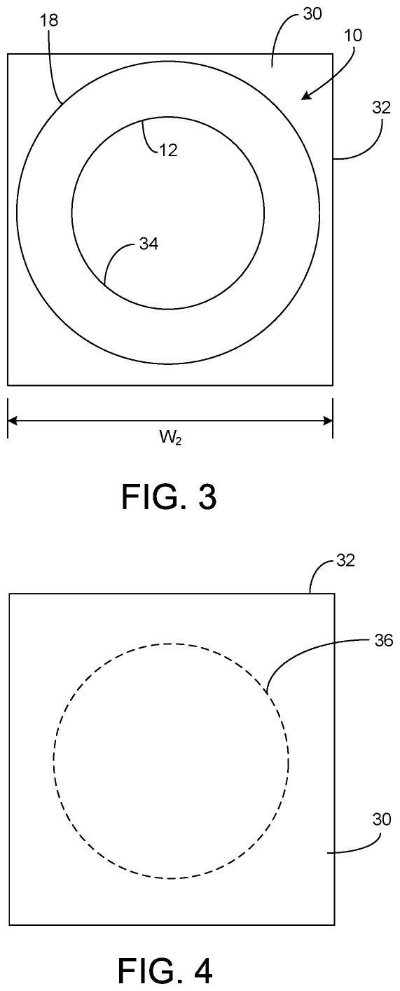

FIG. 3 illustrates the locating collar 10 as positioned on the outer surface 30 of register box 32. FIG. 3 shows that the outer surface 30 of register box 32 has a width W₂. Importantly, the locating collar 10 has the collar 12 and the flange 18 configured in the manner described hereinbefore in connection with FIGS. 1 and 2. Importantly, for the purposes of the present invention, the outer diameter D₁ of the flange 18 will be less than the width W₂ of the outer surface 30 of register box 32. Ultimately, the width W₁ (as shown in FIG. 1) of the flange 18 will be at least as wide as or wider than the insulation within the interior of the register box 32. As such, when the locating collar 10 is placed upon the outer surface 30 of the register box 32, it can be assured that the collar 12 will always be positioned directly above the internal cavity of the register box. Since the width of the insulation will be equal to or less than the width W₁ of the flange 18, this placement is assured. Also, since it is important to place the flange 18 within the width W₂ of the register box 30, the accurate placement of the locating collar 12 is assured. Suitable instructions can be provided to the installer to maintain the outer diameter D₁ of the flange 18 within the perimeter of the register box 32. As such, regardless of the placement of the locating collar 10 on the outer surface 30 of the register box 32, it is assured that the collar 12 will always reside over the internal cavity of the register box. As such, the configuration shown in FIG. 3 will allow the installer to adapt the locating collar 10 to the ductwork of the HVAC system. Also, the locating collar 12 can have various dimensions of the outer diameter D₁ of the flange 18 and the outer diameter D₂ of the collar 12. As such, if smaller ductwork is involved with the HVAC system, a collar can be chosen to match the diameter of such ductwork. Similarly, if a smaller register box is employed with a smaller amount of insulation, a suitable flange 18 can be utilized. This provides a great advantage to workers in that the register box 32 and the locating collar 10 can be supplied separately. The installer only has to choose the appropriate collar 12 and the appropriate flange 18 and choose the appropriate location on the outer surface of the register box 32 in order to properly install the locating collar 10 in the manner to be described hereinafter.

FIG. 4 shows that the further step in the present invention. It can be seen that in FIG. 3 that the locating collar 12 has an inner diameter 34. FIG. 4 shows that the installer can use the locating collar 12 and its inner diameter 34 as a template for marked representation 36 of this inner diameter (or the outer diameter) of the locating collar 34. As such, the marked representation 36 will be indicative of the desired location of the collar 34 with respect to the outer surface 30 of the register box 32. This marked representation will correspond in a location which avoids any unnecessary removal of excess insulation from the interior of the register box. As a result, the proper R-value of the insulation is preserved. Ultimately, after the marked representation 36 is achieved, the worker can use snippers to cut around this marked representation 36 so as to remove the metal material of the register box 30 and expose the insulation therebelow (in the manner described hereinafter). Since the collar 12 is somewhat flexible, accurate cutting around the marked representation 36 is not critical to the installation of the locating collar 10.

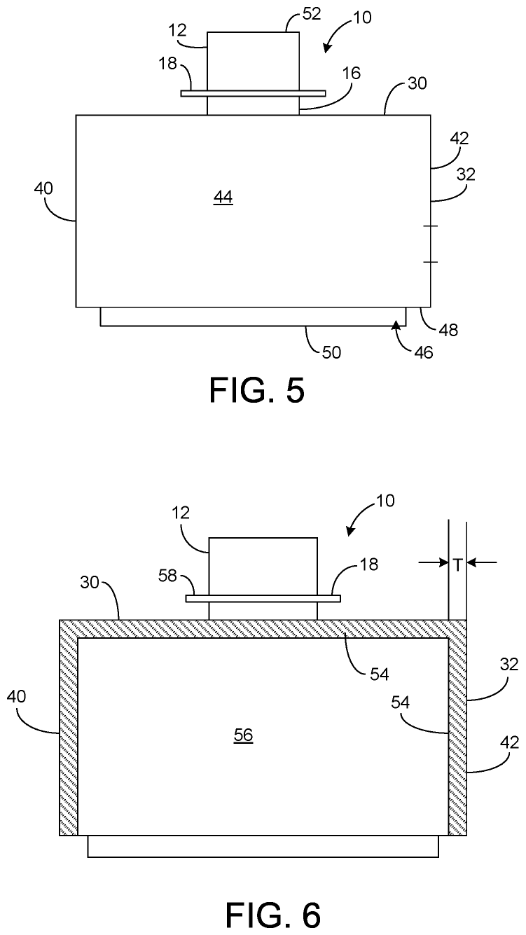

FIG. 5 shows a side view of the register box 32. Register box 32 includes the outer surface 30 at a top thereof. Register box 32 also includes end surfaces 40 and 42 and a side surface 44 extending between the end surfaces 40 and 42. Another side surface (identical decide surface 44) will be formed on the opposite side of the register box 32 (not shown). A flange member 46 extends downwardly from the bottom 48 of the register box 32. Flange member 46 will define an opening 50 at the bottom 48 of the register box 32.

As can be seen in FIG. 5, the locating collar 10 is positioned on the outer surface 30 of the register box 32. Specifically, the second end 16 will bear against the outer surface 30. Flange 18 extends radially outwardly of the outer diameter of the collar 12. In this position, the installer can easily extend a pen (or other marking device) through the open end 52 of collar 12 so as to prepare the marked representation 36 (as shown in FIG. 4). After this marked representation is carried out, the locating collar 10 can be lifted from the outer surface 30 of the register box 32.

FIG. 6 shows the register box 32 as having insulation 54 on an interior thereof. Insulation 54 will extend across the end wall 42, the end wall 40, and the outer surface 30. As such, the insulation 54 will define an interior cavity 56 in the interior of the register box 32. The locating collar 10 is illustrated as positioned on the outer surface 30. The outer surface 30 will be steel, aluminum, or other material, upon which the insulation 54 is applied. In the present invention, the insulation 54 is a foamed polymeric material. A suitable form can be placed into the interior of the register box 32 so as to properly form the foamed polymeric material around the inner surfaces of the register box 32. The insulation 54 will have a thickness T.

In FIG. 6, the locating collar 10 has the flange 18 radiating outwardly from the collar 12. The portion 58 of the flange 18 will have a width greater than the thickness T. As such, no matter where the locating collar 10 is placed on the outer surface 30, as long as the outer diameter D₁ of the flange 18 is within the width D₂ of the outer surface 30, the width D₁ associated with portion 58 of flange 18 will assure that the marked representation (taken from the inner diameter of the collar 12) will always be within the area of the insulation 54 at the outer surface 30 and will not be above the insulation 54 at the end walls 40 and 42. As such, this assures that the collar 12 will always be positioned correctly and directly above the interior cavity 56 of the register box 32.

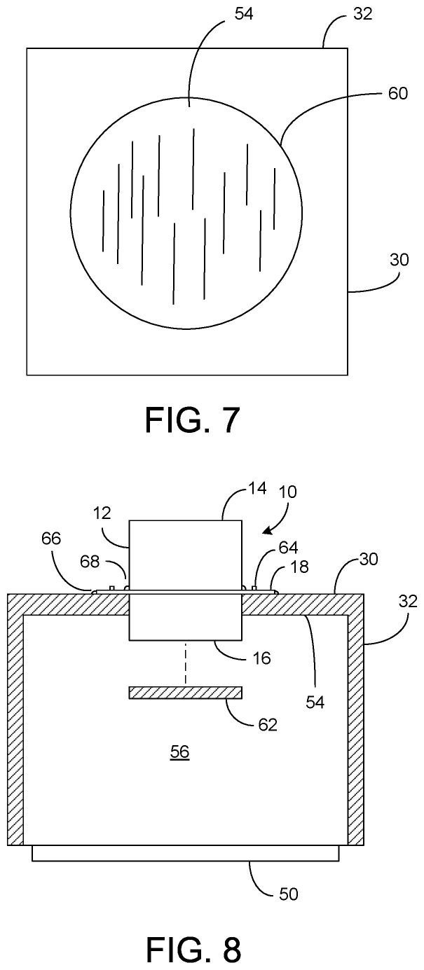

FIG. 7 shows the outer surface 30 of register box 32 after the marked representation has been snipped. In particular, after the snipping of the marked representation 36 (as that shown in FIG. 4) has occurred, there will be a metallic disc that is formed. This metallic disc can be removed from the circular area 60 so as to expose the insulation 54 therebelow. The snipped circular area 60 will have a diameter generally corresponding to the diameter D₂ of the locating collar 10.

FIG. 8 shows the next step for installing the locating collar 10 into the register box 32. In particular, since the end 16 of locating collar 12 is relatively sharp, it can be inserted through the snipped circular area 60 (as shown in FIG. 7) and pushed downwardly so as to penetrate the insulation 54. This can be achieved by downward force applied on the first end 14 of collar 12 and with minor rotations applied to the collar 12. Ultimately, this insertion process will continue until the flange 18 bears against the outer surface 30 of the register box 32. This assures that the second end 16 is now located within the interior cavity 56 of the register box 32 and that the insulation bears tightly against the out diameter of the collar 12. Once this positioning is achieved, a circular disc 62 of the insulation 50 can be pushed out of the second end 16 of the collar 12 and removed from the open end 50 of the register box 32. As such, the open interior 34 of the collar 12 will communicate with the interior cavity 56 of the register box 32.

Once this installation process is achieved, a fastener 64 can be applied to the flange 18 so as to affix the flange 18 against the outer surface 30 of the register box 32. The fastener 64 can be in the nature of a screw. The screw can be applied through the marked areas 28 (as shown in FIG. 2). As such, the flange 18 can be securely mounted onto the outer surface 30 so as to cover the snipped-out circular area 60. A mastic 66 can be applied to the outer diameter of the flange 18 onto the outer surface 30 of the register box 32. The mastic 68 can also be applied between the inner diameter of the flange 18 and the outer diameter of the collar 12. Mastic beads 66 and 68 assure an airtight sealing relationship between the locating collar 10 and the outer surface 30 of the register box 32. The mastic can be in the nature of a UL 181 sealant.

Importantly, in the configuration shown in FIG. 8, there is an improved sealing relationship between the locating collar 10 and the register box 32. The insertion of the collar 12 through the insulation 54 by pushing and rotating will assure a very tight sealing relationship between the outer diameter of the collar 12 and the corresponding surfaces of the insulation 54. This will ultimately be a virtually airtight seal. This manner of installation avoids any unnecessary removal of insulation 54, assures a tight fit, and improves the insulation R-values of the insulation 54. Additionally, since the flange 18 is secured to the outer surface 30 and since the inner diameter of the flange 18 is in a close sealing relationship with the outer diameter of the collar 12, this further improves the air-tight qualities of the insulation. Since the flange 18 is secured to the outer surface 30 through the use of fasteners 64, this assures that the locating collar 10 cannot be dislodged from the register box 32 during installation or movement. Additionally, and furthermore, the application of the mastic beads 66 and 68 to the corresponding surfaces of the outer surface 30, the flange 18 and the collar 12 further assures the air-tight relationship between the locating collar 10 and the register box 32. As such, the locating collar 10 serves as a measuring device, a template, and a mounting flange. Only a minimal amount of insulation is removed. The flange 18 serves as an additional fire barrier. As such, the locating collar 10 assures a better quality product, a better insulated product, and a more easily installed product.

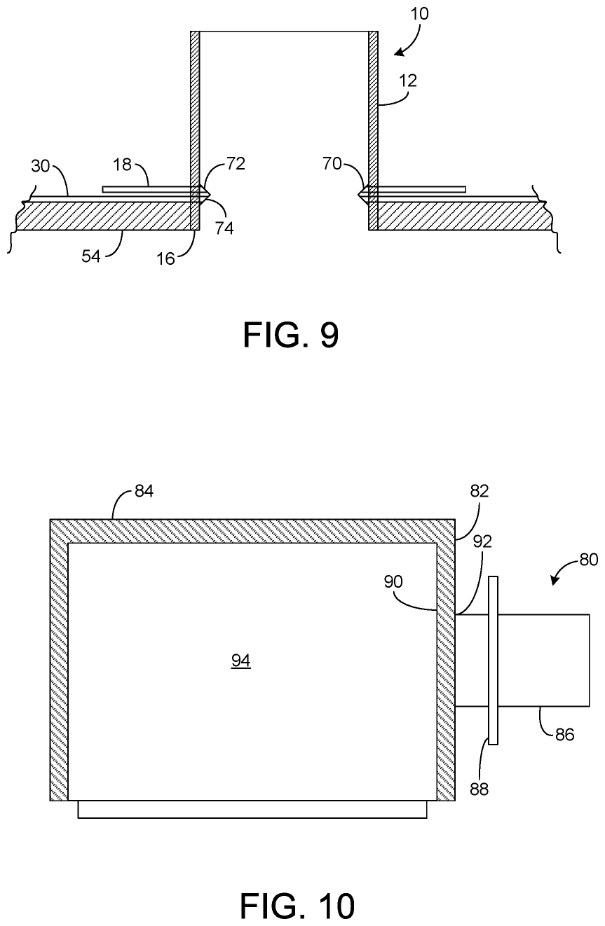

FIG. 9 shows a unique aspect of the present invention. In FIG. 9, it can be seen that the locating collar 10 has collar 12 with a notch 70 formed circumferentially around the outer diameter of the locating collar 12. The flange 18 has its inner diameter 72 received within this notch 70. Additionally, and furthermore, it can be seen that the outer surface 30 of the register box has an edge 74 also received within a notch 70. This essentially creates a “snap-fit” relationship between the locating collar 10 and the metal material of the outer surface 30 of the register box 32. This once again further improves the sealing relationship between the flange and the surfaces of the register box. This installation provides a tactile and somewhat audible presentation to the installer that the locating collar 10 has been properly installed. FIG. 9 further shows the tight sealing relationship between the end 16 of the collar 12 and the insulation 54.

FIG. 10 further shows an alternative arrangement of the present invention. In FIG. 10, it can be seen that the locating collar 80 is positioned against an end side 82 of the register box 84. As such, the end side 82 will actually be the “outer surface 30” in this embodiment. In certain HVAC systems, it will be important to install the locating collar in this end side 82 (or into any of the other sides of the register box). As such, locating collar 80 is applicable to such an installation. Ultimately, the locating collar 80 includes collar 86 and flange 88. As with the previous embodiment, the flange 88 will have an outer diameter D₁. The collar 86 will have an outer diameter D₂. The distance between the outer diameter D₂ of the collar 86 and the outer diameter D₁ of the locating collar 88 will be greater than the thickness of the insulation 90 on the inner surfaces of the register box 82. In this embodiment of the present invention, similar steps can be carried out (as in the previous embodiments) such that the end 92 of the collar 86 will resides though as to open to the interior cavity 94 of register box 82.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A process for forming an insulated register box, the process comprising:
forming an insulation across interior surfaces of a register box, the insulation having a thickness;
placing a locating collar onto an outer surface of the register box, the locating collar having a collar with a flange extending circumferentially therearound;
marking the outer surface of the register box so as to present a representation corresponding to an inner diameter or an outer diameter of the collar;
separating a portion of the outer surface of the register box from a remainder of the register box corresponding to the marked representation so as to expose a portion of the insulation;
penetrating the insulation with the collar until an end of the collar opens to an interior of the insulated register box; and
positioning the flange against the outer surface of the register box.

2. The process of claim 1, the collar having an outer diameter, the flange having an outer diameter, a width of the flange between the outer diameter of the collar and the outer diameter of the flange being greater than the thickness of the insulation.

3. The process of claim 1, the outer surface of the register box having a length dimension or a width dimension, the width dimension greater than an outer diameter of the flange.

4. The process of claim 1, further comprising:
affixing the flange around an outer diameter of the collar in location between opposite ends of the collar.

5. The process of claim 4, the step of affixing the flange comprising:
inserting an internal diameter edge of the flange into a notch formed around the outer diameter of the collar.

6. The process of claim 1, the step of separating comprising:
snipping through a surface of the register box around the marked representation; and
removing the snipped surface from the remainder of the register box.

7. The process of claim 1, the step of penetrating the insulation comprising:
pushing an end of the collar through the insulation until the flange abuts the outer surface of the register box.

8. The process of claim 1, further comprising:
affixing the flange to the outer surface of the register box.

9. The process of claim 8, the step of affixing the flange comprising:
applying a fastener to the flange so as to engage with the outer surface of the register box.

10. The process of claim 1, further comprising:
applying a mastic around an outer diameter of the flange and to the outer surface of the register box.

11. The process of claim 1, wherein the flange has an inner diameter received within a notch formed around a circumference of the collar, process further comprising:
fitting an edge of the outer surface of the register box into the notch of the collar.

12. A locating collar for use with an insulated register box, the locating collar comprising:
a collar having a first end and a second end, said collar having an outer diameter; and
a flange affixed to the outer diameter of said collar, said flange radiating outwardly of said collar, said flange having an outer diameter greater than the outer diameter of the collar, said flange positioned in a location between the first end and the second end of the collar, the second end of said collar adapted to extend through insulation of the insulated register box such that an interior of said collar opens to a cavity within an interior of the insulated register box.

13. The locating collar of claim 12, wherein a distance between the outer diameter of said collar and the outer diameter of said flange is greater than a thickness of the insulation in the insulated register box.

14. The locating collar of claim 13, wherein the outer diameter said flange is less than a width of a surface of the insulated register box.

15. The locating collar of claim 13, said collar have a notch formed therearound, said flange having an inner diameter received in the notch of said collar.

16. An assembly comprising:
a register box having an outer surface and an insulating material applied to an inner surface of said register box, the insulating material having a thickness, the register box having an interior cavity; and
a collar having a flange affixed thereto so as to radiate outwardly of said collar, the flange bearing against the outer surface of said register box, said collar having a portion extending through the thickness of the insulating material so as to have an end opening to the interior cavity of said register box, said collar having another portion extending outwardly of the outer surface of said register box.

17. The assembly of claim 16, said flange being affixed to the outer surface of said register box.

18. The assembly of claim 17, said collar having a notch extending circumferentially therearound, the flange having an inner diameter received within the notch, the outer surface of said register box having an edge received within the notch.

19. The assembly of claim 17, further comprising:
a mastic applied to an outer diameter of the flange and the outer surface of the register box so as to form an air-tight seal therebetween.

20. The assembly of claim 17, wherein an outer diameter of the flange and an outer diameter of the collar define a distance that is greater than a thickness of the insulating material, the flange having an outer diameter less than a width of the outer surface of said register box.
